(19) United States
(12) Patent Application Publication
(10) Pub. No.: US 2010/0287390 A1
(43) Pub. Date: Nov. 11, 2010

(54) DEVICE, SYSTEM AND METHOD FOR COMPUTER NETWORK TRAFFIC MONITORING, DISTRIBUTION AND POWER MANAGEMENT

(76) Inventor: Wayne Yu, Irvine, CA (US)

Correspondence Address: OC PATENT, P.C;ATTN: MATT MUSHET, ESQ, 6332 ROYAL GROVE, HUNTINGTON BEACH, CA, 92648, US

(21) Appl. No.: 12/437,060

(22) Filed: May 7, 2009

(51) Int. Cl. G06F 1/00

(52) U.S. Cl. 713/310; 709/224

(57) ABSTRACT

The presently disclosed device, system and method continuously monitors the network traffic within a local area network (LAN) or wide area network (WAN) between a node and multiple servers. With the use of a configurator device, the system can also manage the power in at least one computer network by activating and deactivating these servers as a function of time. Each individual server can be designated as “active” or “standby.” Standby servers can be powered off, from a signal generated from the configurator to a module, if the rate of traffic drops below a predetermined threshold. The same servers can power back on when the network activity level rises above the same or another predetermined threshold. The system comprises a user interface, which allows a user to monitor network activity and define an upper and lower threshold, a configurator adaptable to configure the system based on the network traffic and the pre-defined thresholds, a plurality of modules that activate or deactivate the servers and may comprise a power distribution unit that works in conjunction with the system over the same communication protocol. The disclosed device and system may also control any associated PDU units used to cool the servers.

### FIELD OF INVENTION

The present invention relates to the field of computer networking. More specifically, the invention relates to the field of computer network monitoring, traffic distribution and power management based on network traffic rate.

### BACKGROUND OF THE INVENTION

Since the introduction of computers and computerized machinery, electrical power consumption management has been a key issue in improving technology. Rapid growth of computer networks, server farms and cooling systems for computers have created an increased demand for power consumption. Various methods have been developed to reduce overall power consumption within large computer organizations, especially computer networks, however, this creates a more inefficient network. Also, most of the conventional methods for power management focus on managing power in a single central processor unit.

Take the situation for example that someone wants to rent a car for the weekend because they are going to make a very long road trip. The typical renter will put a great deal of thought into which model of car they select, with the “full-size” car being the most expensive and the “compact” car being the least expensive. The person may select the compact car because it can save them twenty dollars per day. However, in actuality this is not the most important decision to be made because the cost of fuel, and other operational costs, for the trip will greatly exceed the fixed cost of renting the car. This precisely describes the situation in data centers and server farms today.

Large companies, with multi-node computer systems and companies such as Yahoo® and Google® which operate a large number of servers for storing information must constantly be “driving” and using energy. While selecting powerful computing systems is important; selecting efficient computing systems that can save energy in the long haul is even more important. Unfortunately, these companies do not have the opportunity to purchase computers like the typical laptop, which come complete with power-save and hibernation modes. The computers built for large-scale server operation simply do not have this feature. They are constructed on the premise that optimum efficiency is equivalent to full power all of the time. This is partially true because each node in a network system needs to be on call at any one time. Depending on the network traffic rate, different nodes or servers may need to be active at different times, and their response time is greatly increased if they can remain at full power. However, this leads to an enormous waste of power when these nodes or servers are inactive, idle or even not being used to their full capacity. Even if unused servers are slowed down, or run at half speed, there is still a waste of power.

Therefore, there exists a need for a networked system to be able allocate just the right amount of power to each node as is needed by that node at any one time. As has been suggested in different ways, this requires the network to “know” the total amount of traffic that will reach it ahead of time, “know” the capacity of each of its servers, and be able to control the power levels being dedicated to each of its servers. It further requires the network to change this power allocation as a function of network traffic over time. This primarily works the best when one group of servers are powered on and one group of servers are powered off with none in the “in-between” state, requiring a component of the network to only power on servers that are needed and only distribute traffic to powered servers. The present disclosure provides for a novel device and method that has not previously been suggested in the prior art and accomplishes these tasks at a minimum.

One prior art reference, taught in U.S. Pat. No. 5,954,820 issued to Hetzler on Sep. 21, 1999 provides for a method of managing power in a portable computer. The method uses past access history of the various electrically-powered computer components and a prediction of future user demands to determine power-save mode entry and exit conditions. The component or the computer system keeps track of the access patterns. Each component access is detected and used to compute a current access frequency. Since the method utilizes historical data and a only a prediction of usage data to put individual components in power-save or exit-mode, the disclosed method is not the most efficient method for managing power in the computer network.

Next, U.S. Pat. No. 5,958,055 issued to Evoy on Sep. 28, 1999 discloses an off-hook state of a telephone associated with a computer system for disabling the power management unit of the computer to prevent premature power shutdown while the telephone is being used. The computer system includes a bus system and a central processing unit coupled to the bus system. The central processing unit has a normal power mode and a power saving mode. A telephony interface coupled to the bus system has a port for coupling to a telephone system network. The power management unit causes the central processing unit to be in a power saving mode when both bus system activity and telephony interface activity are less than a predetermined level of activity. However, the device does not take into consider the level of network traffic for controlling the power in the network.

Also, U.S. Pat. No. 6,591,368 issued to Ryu on Jul. 8, 2003 provides for a method and an apparatus for controlling power of a computer system using a wake up local area network (LAN) signal. The method includes steps of powering devices when the wake up LAN signal is sensed in the power-off state of the computer system and manages power in certain peripherals of the computer system from a remote location in a computer network. However, a problem with the wake up LAN is that the computer system may have the wake up LAN signal in a disabled condition. This may result in repeated attempts to wake up the computer system without any hope of succeeding. Moreover, such a device does not maintain functional performance of the computer system while managing the power consumption.

Then, U.S. Pat. No. 6,859,882 issued to Fung on Feb. 22, 2005 provides for an apparatus and a method for managing power consumption and workload in computer system and information servers. The apparatus provides a dynamic server power management and optional dynamic workload management for multi-server environment. However, the device lacks the ability to let a user specify the role of each computer and lacks the ability for a minimum threshold to be set when the server can be completely powered off. Such a device also has a very complex construction and hence the maintenance cost will be very high.

Therefore, as previously stated, there is a need for a device that will provide an efficient and economical system and method for managing power in a computer network. Such a needed device would manage power by monitoring actual network traffic in the computer network. Further, such a device would not make repeated attempts to power on and power off the servers in the network. Still further, such a device would maintain all functional performances while managing power consumption. Moreover, such a device would be easy to operate. The present disclosure accomplishes these objectives.

### SUMMARY OF THE INVENTION

These and other objectives of the claimed invention will no doubt become obvious to those of ordinary skill in the art after reading the following detailed description of the preferred embodiment that is illustrated in the various figures and drawings.

The present disclosure is a device, system and method for managing power in at least one computer network by monitoring and potentially redistributing network traffic. The device comprises a configurator that acts as a gateway device to monitor network traffic, configure a plurality of servers and send a signal to activate or deactivate a plurality of servers based on the level of network activity and at least one user-defined threshold. The system comprises a user interface, that allows a user to monitor network traffic and configure at least one computer network based on a user defined power management policy; a configurator, adaptable to configure the system based on the network traffic and a predetermined threshold level set by the user; and a module that activates or deactivates at least one server. The system may optionally comprise a power distribution unit that works with the configurator and a module through various communication protocols. In the preferred embodiment, the user interface will also comprise a monitor.

During operation, the system deactivates at least one server when network activity is below a predetermined threshold and activates at least one server when network activity is equal to or greater than a predetermined threshold, thereby managing power in the at least one computer network. The predetermined threshold level may include a low watermark or a high watermark. Activating and deactivating may include completely powering on or powering off a server. The system then stops sending network traffic to a deactivated server while the network traffic is below the low watermark. A deactivated server may be powered back on or activated by the system when the network traffic rises above a high watermark. The present disclosure also comprises a method of using such a system.

The present invention facilitates an efficient and economical way to manage power in a computer network. Such a needed device manages power in at least one computer network by monitoring network traffic, potentially redistributing traffic based on the level of inbound and outbound network activity and user-defined or computer-defined threshold levels, and powering down servers that are not needed. Further, such a device does not make repeated attempts to power on and power off the servers in the network. Still further, such a device maintains the functional performance of the device while managing power consumption. Moreover, such a device is easy to operate by acting as a network gateway device that is completely configurable. Other features and advantages of the present invention will become apparent from the following more detailed description, taken in conjunction with the accompanying drawings, which illustrate, by way of example, the principles of the invention.

### BRIEF DESCRIPTION OF THE DRAWINGS

FIG. 1 illustrates the architectural overview of the system hardware in the preferred embodiment of the present disclosure

FIG. 2 illustrates an operational flowchart showing the logic used by the system in routing information to the servers and changing power states based on network activity and the user defined threshold.

FIG. 3 illustrates an architectural overview of the hardware within the configurator device in the preferred embodiment of the present disclosure.

### DETAILED DESCRIPTION OF THE PREFERRED EMBODIMENT

In the following description of the various embodiments, reference is made to the accompanying drawings, which form a part hereof, and in which is shown by way of illustration various embodiments in which the invention may be practiced. It is to be understood that other embodiments may still be utilized and structural and functional modifications may be made without departing from the scope and spirit of the present invention.

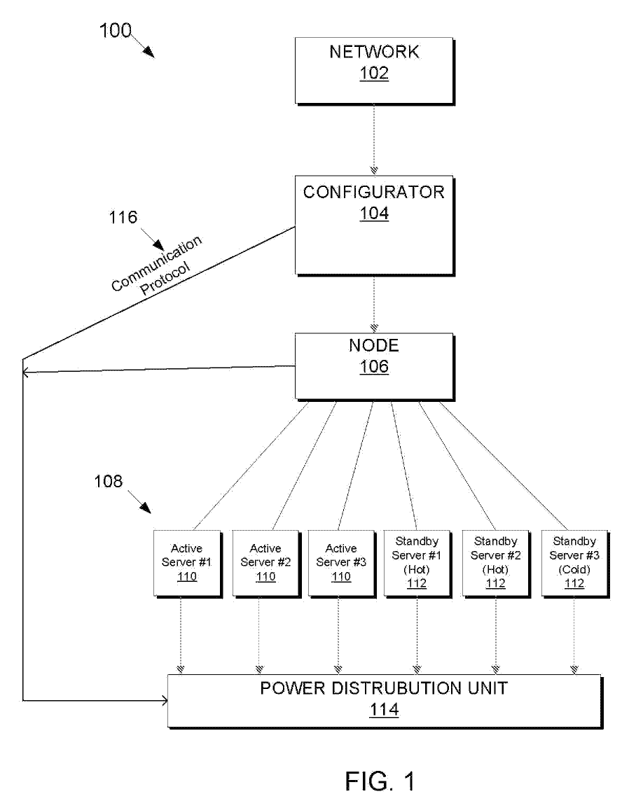

Now referring to FIG. 1, a block diagram illustrating the system architecture of a system 100 for managing power in at least one computer network 102 by monitoring network traffic coming from at least one network 102 is shown. The system 100 comprises of a monitor and user interface (not shown) that allow a user to configure the at least one computer network based on a user defined power management policy, a configurator 104 adaptable to configure the system 100 based on the network traffic and a predetermined threshold level preferably set by the user, a power distribution unit (PDU) 114 that works with the configurator 104 through at least one communication protocol 116 and a module (not shown), preferably within a server 108, that enables the at least one server 108 to stop running. System 100 powers off the at least one server 108 that does not participate in services thereby managing power in the at least one computer network 102. Alternatively, the status of servers 108 can be manually set by a user as active or standby, Standby servers 112 do not always actively participate in the provision of services to the network. Standby servers 112 will either be hot if they are powered on, running and providing services or cold if they are powered down and not actively participating in services. The at least one powered off server 108 is powered back by the configurator 104 when the network traffic rises above the predetermined threshold level. The predetermined threshold level may include a low water mark, a high water mark or the like. In the preferred embodiment of the present disclosure, the threshold levels are defined by the user but could also be envisioned to be generated by predictions based on past history, current activity or the like. Network 102 may be an internet and/or an intranet and may be of a wired or wireless variety.

Still referring to FIG. 1, in the preferred embodiment, the system 100 monitors the network traffic within the at least one computer network 102 between at least one node 106 and the at least one server 108 in bytes/second and prioritizes the amount of the network traffic to each active server 110 and standby server 112 at the node 106. This prioritizing can be configured by the user, partially configured by the user or set automatically. In the preferred embodiment, node 106 may connect and come between configurator 104 and at least one server 108. Node 106 may be a common variety of router or switch. Module (not shown) may be a software or combination of software and hardware that can be installed in the at least one server 108. Alternatively, the modules may be located elsewhere within system 100, but still have the capability to receive command signals, physically alter the components of the server and possibly send back signals to configurator 104, i.e. status signals. In the preferred embodiment of the present disclosure, the monitor is adaptable to monitor the network traffic in the at least one computer network. The monitor could be envisioned to be as simple as an LED light to a complex assortment of viewing screens. The user interface and the monitor also allow the user to send at least one command to the PDU 114 for powering on and powering off the at least one server 108 through the at least one communication protocol 116. The at least one communication protocol 116 may be a transmission control protocol/internet protocol (TCP/IP), a universal serial bus/internet protocol (USB/IP), any other IP protocol, non IP protocol or a combination of these protocols sent across a recommended standard 232 (RS 232) line or the like. The PDU 114 may be located within the system 100 or located separately from the system 100.

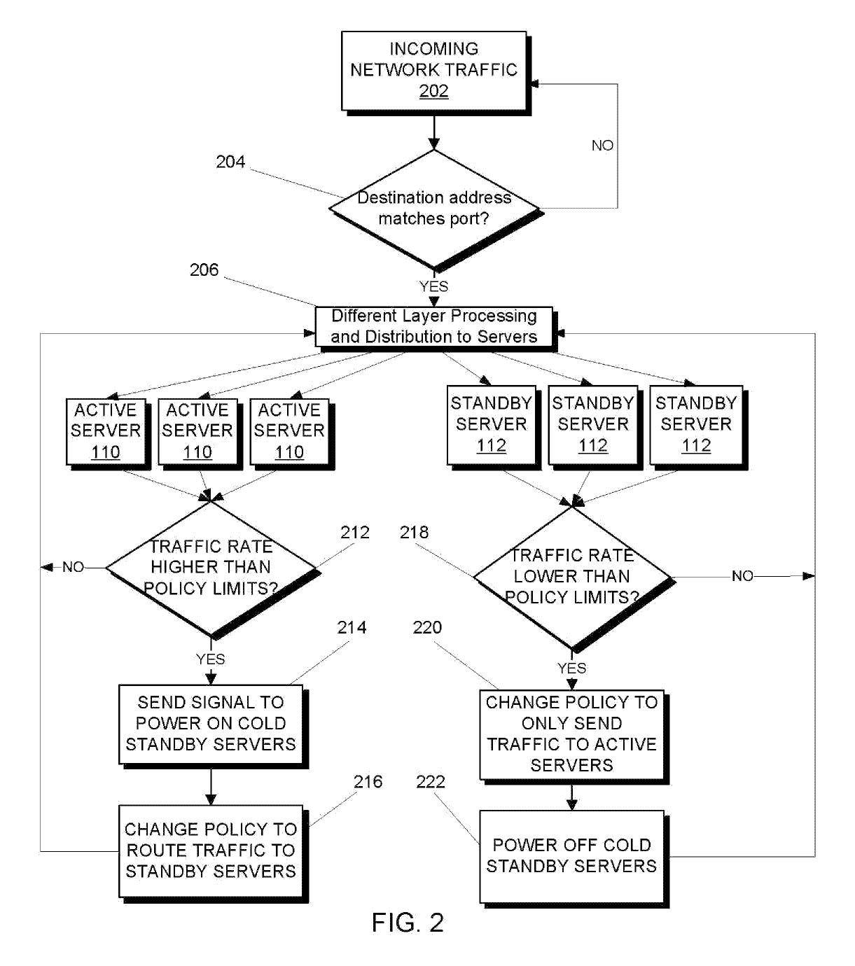

Now referring to FIG. 2, an operational flowchart of the system 100 illustrating the routing of the network traffic to the at least one server 108 is shown. A check is made at block 204 by the system to verify whether the destination address of incoming network traffic, as shown at block 202, matches a particular port. If the check made at block 204 is evaluated to “Yes”, the incoming network traffic is processed at different layers of the at least one communication protocol and distributed to the at least one server at block 206. If the check made at block 204 is evaluated to “No”, the control is transferred back to block 202. Preferably, the system measures the amount of network traffic being distributed to the at least one server 108. After the logic reaches the point of distribution to the servers, two more checks are made depending on whether the traffic Was sent to an active server 110 or a standby server 112. Preferably at this point, the servers have already been designated as active or standby, either manually by the user, by the configurator or by a combination of both. If the logical operation sent the traffic to active server 110, a check is made at block 212 to determine whether the network traffic reached a high water mark. If the check made at block 212 is true and the traffic did indeed reach a high water mark, then the system issues the at least one command as shown at block 214 to power on the at least one standby server 112. The user defined power management policy is then changed as shown at block 216 to route the network traffic to the at least one standby server 112. If the check made at block 212 is evaluated to false and the high water mark has not been reached, control is directly transferred back to the block 206 and the network continues to run as normal. If the logical operation sent the traffic to standby server 112, a check is made at block 218 to determine if the network traffic is below the low water mark. If the check is true then the user defined power management policy is changed as shown at block 220 to route the network traffic to an active server 110. The system then sends the at least one command as shown at block 222 to power off any standby server 112. The control is transferred to the block 206 for distributing the network traffic to the active server or passive servers 108. If the check made at block 218 is false then control is directly transferred back to the block 206.

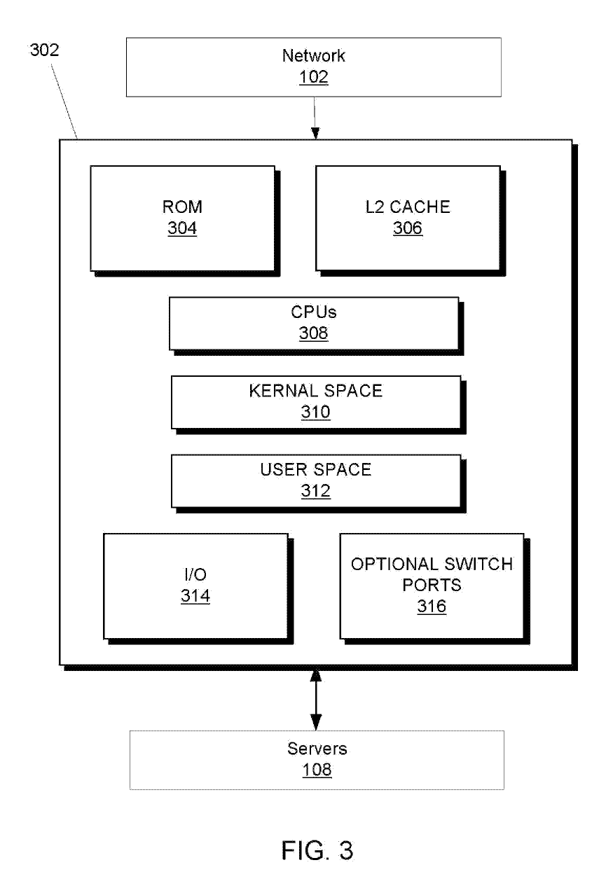

Now referring to FIG. 3, a block diagram illustrating hardware components 302 of the configurator 104 is shown. Configurator 104 preferably comprises a read only memory (ROM) 304, Level 2 (L2) cache 306, central processing units (CPUs) 308, kernel space 310, user space 312, input/output (I/O) port 314, and optional switch ports 316. CPUs 308 perform a plurality of operations such as processing or decision making. The various components 302 of configurator 104 configure system 100 (not shown) to optimize the number of servers 108 that are used within system 100. This optimization of system 100 allows it to power off under-used standby servers 112 and more fully use active servers 110, thereby saving power in at least one computer network. Configurator 104 thus serves as a gateway device that can redirect network traffic to active and standby servers based on a network workload. Alternatively, it could reduce performance of specific servers in various ways, for example, based on a CPU 304 clock. However, a key advantage of the present disclosure is for configurator 104 to be able to reactivate or turn on previously deactivated or powered off servers. System 100 may also be adapted to control the power state of at least one air conditioning unit or PDU 114 (not shown) associated with system 100. System 100 is especially important in conserving power in server farms.

Now referring to FIGS. 1-3, the presently disclosed system, method and device manage power consumption and workload in at least one computer system or computer network. The independently modulated computers, servers or sections of the network are controlled by one or a combination of user input parameters, system architecture and device configuration. Thus, the network can be operated at its highest performance level and at the lowest power state.

The present invention includes any novel feature or combination of features disclosed herein either explicitly or any generalization thereof. While the invention has been described with respect to specific examples including presently preferred modes of carrying out the invention, those skilled in the art will appreciate that there are numerous variations and permutations of the above described apparatus. Thus, the spirit and scope of the invention should be construed broadly as set forth in the appended claims.

What is claimed is:

1. A system for managing power in an at least one computer network by monitoring network traffic and activating or deactivating a plurality of servers based in part by the network traffic, comprising:
a user interface that allows a user to configure the at least one computer network based on a user-defined power management policy and monitor the network traffic in the at least one computer network,
a configurator adaptable to configure the system based on the network traffic and at least one predetermined threshold level; and
a plurality of modules that enable at least one of the plurality of servers to activate or deactivate when a signal is sent from the configurator;
whereby the system manages power in the at least one computer network.

2. The system of claim 1, further comprising a power distribution unit that works with the configurator and the plurality of modules.

3. The system of claim 1, wherein the at least one computer network comprises a local area network, a wide area network an intranet. an internet, a wired network, a wireless network or a combination of the local area network, the wide area network the intranet, the internet, the wired network and the wireless network.

4. The system of claim 1, wherein the network traffic includes inbound traffic, outbound traffic or a combination of the inbound traffic and the outbound traffic.

5. The system of claim 1, wherein at least one of the plurality of servers is located on a terminal, a workstation, another server, a desktop or a laptop computer.

6. The system of claim 1, wherein the user interface further comprises a monitor.

7. The system of claim 1, wherein the power management policy is at least partially defined by the configurator.

8. The system of claim 1, wherein the configurator monitors the at least one network in real time.

9. The system of claim 1, wherein the configurator labels each of the plurality of servers as active or standby.

10. The system of claim 1, wherein the configurator indirectly signals at least one of the plurality of modules to activate one of the plurality of servers or deactivate at least one of the plurality of servers.

11. The system of claim 1, wherein the at least one predetermined threshold level is a high watermark or a low watermark.

12. The system of claim 11, wherein the system stops sending the network traffic to the at least one server and deactivates the at least one server when the network traffic is below the low watermark.

13. The system of claim 11 wherein the system activates the at least one server when the network traffic is equal or greater than the high watermark.

14. The system of claim 1, wherein at least one of the plurality of modules reside on the at least one plurality of servers.

15. A device for managing power in an at least one computer network by monitoring network traffic, configuring a plurality of servers and activating or deactivating the plurality of servers based on a level of the network traffic and at least one user-defined threshold, comprising:
a central processing unit, the central processing unit further comprising proprietary firmware;
a read only memory to store activation status of the plurality of servers;
a level 2 cache;
kernel space;
user space, and
an input/output channel

16. The device of claim 15, further comprising a switch port.

17. A method for managing power in at least one computer network the method comprising the steps of:
providing a user interface to configure the at least one computer network;
monitoring the network traffic in the at least one computer network;
configuring a system for power management based on the network traffic rate and at least one predetermined threshold level;
assigning a status to each of a plurality of servers in the at least one computer network;
sending an activation signal to the at least one of the plurality of servers when the network traffic rate is equal or greater than a first of the predetermined threshold levels and a deactivation signal to an at least one server when the network traffic rate is less than a second of the predetermined threshold levels; and
distributing the network traffic to at least one of the plurality of servers.

18. The method of claim 17 wherein the at least one predetermined threshold level is defined by a user.

19. The method of claim 17, wherein the status of each of the plurality of server is active or standby.

20. The method of claim 17, wherein the network traffic is distributed by a power distribution unit.
